(19) United States
(12) Patent Application Publication
(10) Pub. No.: US 2026/0016636 A1
(43) Pub. Date: Jan. 15, 2026

(54) COMPACT WAVELENGTH SELECTIVE SWITCH

(71) Applicant: Molex, LLC, Lisle, IL (US)

(72) Inventors: Jefferson Lynn Wagener, Morristown, NJ (US); Jeff Alexander Wagner, Long Valley, NJ (US)

(21) Appl. No.: 19/264,915

(22) Filed: Jul. 10, 2025

Related U.S. Application Data
(60) Provisional application No. 63/669,257, filed on Jul. 10, 2024.

(51) Int. Cl. G02B 6/293; G02B 6/27; G02F 1/13

(52) U.S. Cl. CPC G02B 6/29302; G02B 6/2706; G02B 6/276; G02B 6/29311; G02B 6/29373; G02F 1/1326

(57) ABSTRACT

An optical device is provided that incorporates twin wavelength selective switches (WSSs), is compact, and avoids using a Wollaston prism. Additionally, the path lengths traversed by wavelength components through each WWS may be the same. The optical device may include a first subset and second subset of optical ports, where each of the first and second subsets can operate as an independent WSS. An optical arrangement of the optical device may support optical coupling between (i) any ports in the first subset of ports for light in a first polarization state and (ii) any ports in the second subset of ports for light in a second polarization state. The optical device may further include beam directing optics for coupling wavelength components of an optical beam from a focusing element to a programmable optical phase modulator and from the programmable optical phase modulator to the focusing element.

### FIELD OF THE INVENTION

The present disclosure relates generally, but is not limited, to wavelength selective switches (WSSs). More specifically, the present disclosure relates to an optical device including a first subset and second subset of optical ports, where each of the first and second subsets can operate as an independent WSS.

### BACKGROUND

In an optical communication network, optical signals having a plurality of optical channels at individual wavelengths (i.e., channels), are transmitted from one location to another, typically through a length of optical fiber. An optical cross-connect module allows switching of optical signals from one optical fiber to another. A wavelength-selective optical cross-connect, or wavelength selective switch (WSS), allows reconfigurable wavelength-dependent switching, that is, it allows certain wavelength channels to be switched from a first optical fiber to a second optical fiber while letting the other wavelength channels propagate in the first optical fiber, or it allows certain wavelength channels to be switched to a third optical fiber. An optical network architecture based on wavelength-selective optical switching has many attractive features due to the ability to automatically create or re-route optical paths of individual wavelength channels. It accelerates service deployment, accelerates rerouting around points of failure of an optical network, and reduces capital and operating expenses for a service provider, as well as creating a future-proof topology of the network.

The number of functional individual WSSs that are physically incorporated in a single unit may be increased from one to two with twin WSSs. That is, a single LCoS (liquid crystal on silicon) array can be partitioned to deliver multiple WSSs in a single unit. However, such WSSs may be insufficiently compact for certain applications and may employ expensive components such as a Wollaston prism.

### SUMMARY

In one aspect, an optical device is provided which can incorporate twin WSSs, is compact, and avoids the use of a Wollaston prism. In addition, the path lengths traversed by wavelength components through each WWS is the same.

In another aspect, an optical device is provided that includes an optical port array having a plurality of optical ports for receiving optical beams. An optical arrangement is also included for allowing optical coupling between (i) any optical ports in a first subset of the plurality of optical ports for light in a first polarization state but not in a second polarization state and (ii) any optical ports in a second subset of the plurality of optical ports for light in the second polarization state but not in the first polarization state, wherein the first and second polarization states are orthogonal to one another. A dispersion element receives an optical beam from any of the optical ports after traversing the optical arrangement and spatially separating the optical beam into a plurality of wavelength components. A focusing element focuses the plurality of wavelength components. A programmable optical phase modulator receives the focused plurality of wavelength components, the programmable optical phase modulator being configured to steer the wavelength components to a selected one of the optical ports. A beam directing optical arrangement couples the plurality of wavelength components from the focusing element to the programmable optical phase modulator and from the programmable optical phase modulator to the focusing element. The beam directing optical arrangement includes: a first prism including an input surface, an output surface and an oblique surface; a second prism including an input surface and an oblique surface, the input surface of the second prism being positioned to face the oblique surface of the first prism; an optical element disposed between the input surface of the second prism and the oblique surface of the first prism, the optical element being configured to reflect the wavelength components in the first polarization state and transmit the wavelength components in the second polarization state; and a polarization converting reflector positioned to receive the wavelength components reflected from the optical element in the first polarization state and reflect the wavelength components in the second polarization state so that the wavelength components are directed through the first prism, the optical element and the second prism in the second polarization state and to the programmable optical phase modulator. The wavelength components in the second polarization state that are focused by the focusing element and directed through the first prism and the optical element are directed through the oblique surface of the second prism and to the programmable optical phase modulator.

In another aspect, the second prism of the beam directing optical arrangement has a third surface with a reflective coating, the second prism being arranged so that the wavelength components in the second polarization state are reflected from the third surface before being directed through the oblique surface of the second prism and to the programmable optical phase modulator.

In another aspect, the optical element is a coating on the input surface of the second prism or the oblique surface of the first prism.

In another aspect, the first and second polarization states are linearly polarized states.

In another aspect, the first polarization state is a horizontal polarization state and the second polarization state is a vertical polarization state.

In another aspect, the programmable optical phase modulator includes a liquid crystal- based phase modulator.

In another aspect, the liquid crystal-based phase modulator is a LCoS device.

In another aspect the dispersion element is selected from the group consisting of a diffraction grating and a prism.

In another aspect, an optical device includes an optical port array having a plurality of optical ports for receiving optical beams; An optical arrangement allows optical coupling between (i) any optical ports in a first subset of the plurality of optical ports for light in a first polarization state but not in a second polarization state and (ii) any optical ports in a second subset of the plurality of optical ports for light in the second polarization state but not in the first polarization state, wherein the first and second polarization states are orthogonal to one another. A dispersion element receives an optical beam from any of the optical ports after traversing the optical arrangement and spatially separating the optical beam into a plurality of wavelength components. A focusing element focuses the plurality of wavelength components. A programmable optical phase modulator receives the focused plurality of wavelength components, the programmable optical phase modulator being configured to steer the wavelength components to a selected one of the optical ports. A beam directing optical arrangement directs the wavelength components to couple the plurality of wavelength components from the focusing element to the programmable optical phase modulator and from the programmable optical phase modulator to the focusing element. The beam directing optical arrangement includes: a polarization converting reflector, a first prism and a second prism; an optical element receiving the focused plurality of wavelength components from the beam focusing optics after traversing the first prism, the optical element being configured to discriminate between the wavelength components in the first polarization state and the wavelength components in the second polarization state such that the wavelength components in the first polarization state are directed to the polarization converting reflector and the wavelength components in the second polarization state are directed through the second prism and to the programmable optical phase modulator. The wavelength components directed to the polarization converting reflector in the first polarization state are reflected by the polarization converting reflector in the second polarization state and directed through the first prism, the optical element and the second prism and to the programmable optical phase modulator.

In another aspect, the optical element is configured to reflect the wavelength components in the first polarization state to the polarization converting reflector.

In another aspect, the second prism has a reflective surface that reflects the wavelength components in the second polarization state that have not been reflected by the polarization converting reflector such that the wavelength components in the second polarization state are directed to the programmable optical phase modulator after traversing an oblique surface of the second prism.

In another aspect, the programmable optical phase modulator is oriented so that an optical axis through the optical ports is orthogonal to a normal to a surface of the programmable optical phase modulator.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure.

### BRIEF DESCRIPTION OF THE DRAWINGS

To facilitate a fuller understanding of the present disclosure, reference is now made to the appended drawings. The drawings should not be construed as limiting the present disclosure but are intended only to illustrate different aspects and embodiments of the disclosure.

FIG. 1A is a schematic illustration in a top view of one example of an optical device in accordance with some embodiments of the present disclosure.

FIG. 1B is a schematic illustration in a side view of the optical device of FIG. 1A showing light being coupled between two ports in a subset of ports in accordance with some embodiments of the present disclosure.

FIG. 1C is a schematic illustration in a side view of the optical device of FIG. 1A showing light being coupled between two ports in a subset of ports in accordance with some embodiments of the present disclosure.

### DETAILED DESCRIPTION

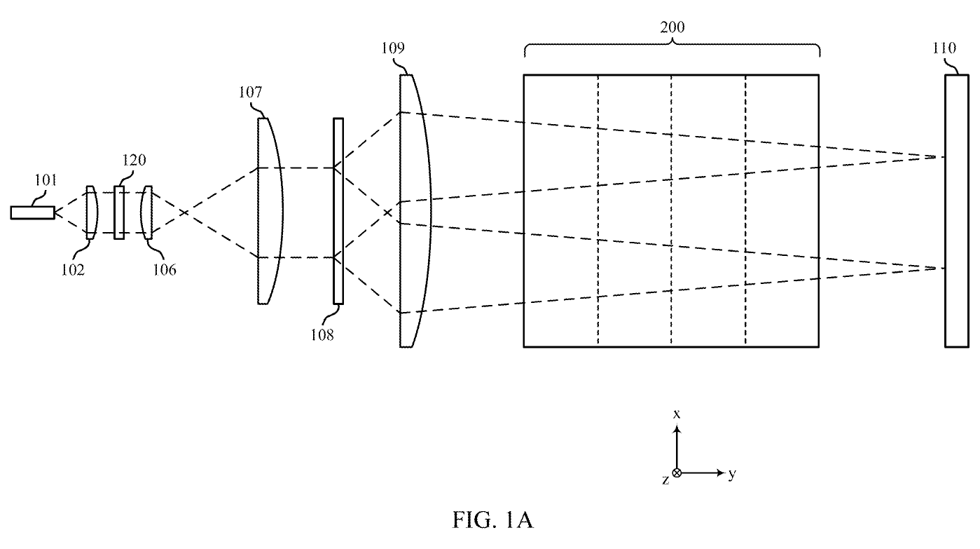

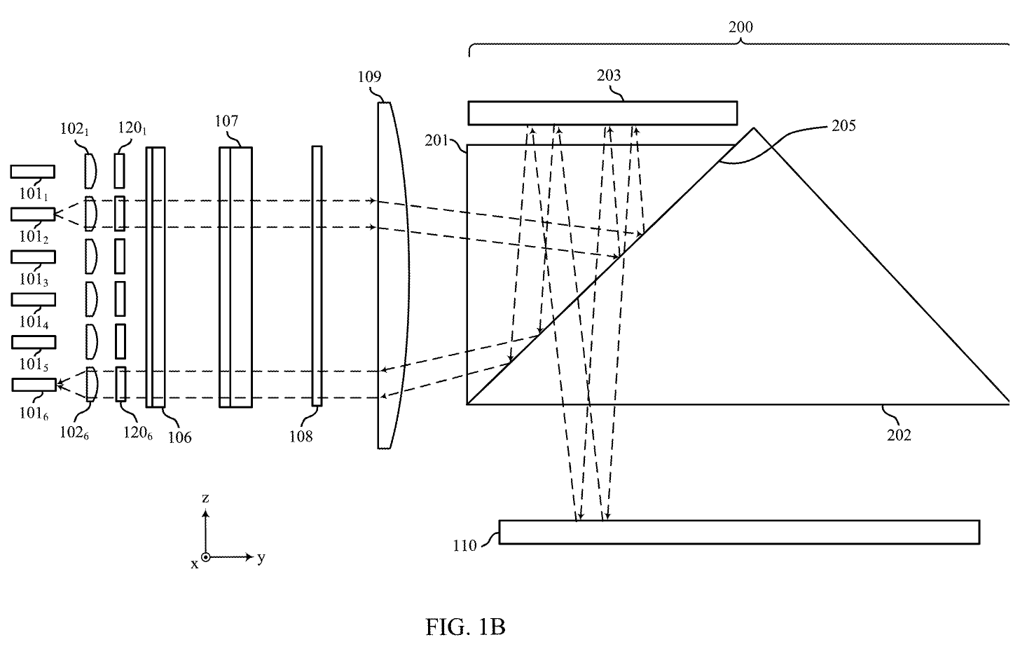

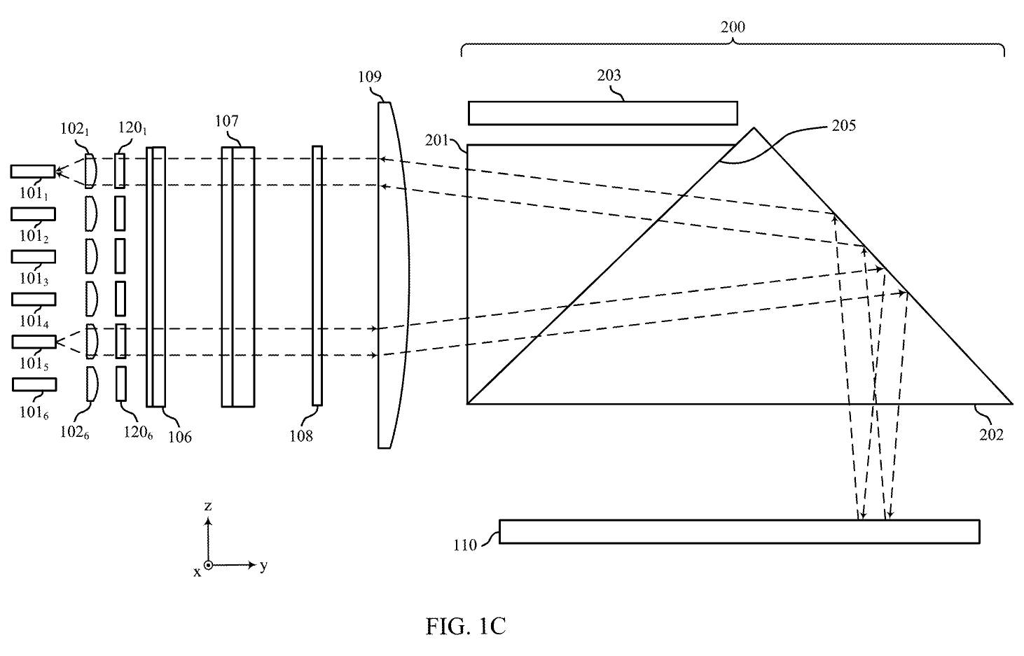

FIG. 1A is a schematic illustration in a top view, and FIGS. 1B and 1C are schematic illustrations in side views, of one example of an optical device such as an optical device that incorporates free space wavelength selective switches (WSSs). Light is input and output to the optical device through optical waveguides such as optical fibers which serve as input and output ports. As best seen in either FIGS. 1B or 1C, a fiber collimator array 101 may comprise a plurality of individual input and output fibers 101₁through 101₆, which are respectively coupled to collimators 102₁through 102₆. Light from one or more of the fibers 101 is converted to a free- space beam by the collimators 102. While the fiber array 101 only shows six optical fiber/collimator pairs in FIGS. 1B and 1C, more generally any suitable number of optical fiber/collimator pairs may be employed.

Optical arrangement 120 receives the free-space beams exiting from the collimators 102. Optical arrangement 120 is internally configured so that only light in one polarization state is coupled between one subset of the input and output ports and only light in the orthogonal polarization state is coupled between another subset of the input and output ports. For instance, in the example illustrated in FIGS. 1A-1C, the optical arrangement 120 is configured so that fibers 101₁, 101₃and 101₅define one subset (e.g., a first subset) of optical ports and fibers 101₂, 101₄and 101₆define another subset (e.g., a second subset) of optical ports. More specifically, in this example, the optical arrangement 120 is configured so that only light in a vertically polarized state can be communicated between fibers 101₁, 101₃and 101₅and only light in a horizontally polarized state can be communicated between fibers 101₂, 101₄and 101₆. More generally, the two subsets of optical ports may or may not have an equal number of ports in them and the orthogonal polarization states that distinguish between them are not limited to linear polarization states. In one particular implementation, optical arrangement 120 may for example comprise an optical isolator of the type described in U.S. Pat. No. 10,228,517, which is hereby incorporated by reference in its entirety.

As best seen in FIG. 1A, a telescope or beam expander is formed from cylindrical lens elements 106 and 107. The telescope magnifies the light beams from the fiber array 101 and optically couples them to a wavelength dispersion element 108 (e. g., a diffraction grating or prism) which separates the free space light beams into their constituent wavelength components or channels. The wavelength dispersion element 108 acts to disperse light in different directions on an x-y plane according to its wavelength. The wavelength components from the dispersion element 108 are directed to beam focusing optics 109. Beam focusing optics 109 direct the wavelength components to beam directing optics 200, which in turn couples the wavelength components from the beam focusing optics 109 to a programmable optical phase modulator 110, which may be, for example, a liquid crystal-based phase modulator such as an LCoS (liquid crystal on silicon) device or a (micro-electro-mechanical systems) MEMs-based device. Beam directing optics 200 are schematically shown unfolded in FIG. 1A. As depicted in the figures, the wavelength components are dispersed along the x-axis, which is referred to as the wavelength dispersion direction or axis. Accordingly, each wavelength component is focused on an array of pixels extending in the y- direction on the programmable optical phase modulator 110. By way of example, and not by way of limitation, only two extreme wavelength components are shown in FIG. lA being focused on the programmable optical phase modulator 110 along the wavelength dispersion axis.

As best seen in FIGS. 1B and 1C, after reflection from the programmable optical phase modulator 110, each wavelength component can be coupled back through the beam directing optics 200, beam focusing optics 109, wavelength dispersion element 108, optical elements 106 and 107 and optical arrangement 120 to a selected fiber in the same subset of fibers that served as the input port. That is, the output ports to which the wavelength components are able to be directed are constrained by the optical arrangement 120 so that they can only receive light in the same polarization state as the light that exited the optical arrangement 120 upon receipt from the input port.

FIG. 1B shows the path of a beam which originates in fiber 101₂and is horizontally polarized upon exit from optical arrangement 120. Beam directing optics 200 comprise first prism 201, second prism 202, and polarization converting reflector 203. A coating or other structure 205 (e.g., an optical element) is located at the common interface of the first prism 201 and the second prism 202 which allows undeviated transmission of vertically polarized beams and which causes specular reflection of horizontally polarized beams. Examples of such coatings or structures are well known, one example of which is found in U.S. Pat No. 2,403,731.

In operation, the horizontally polarized beam originating at fiber 101₂traverses a first portion of first prism 201 and is reflected at the common interface of first prism 201 and second prism 202 by the coating or other structure 205. The reflected beam traverses a second portion of first prism 201, exits and couples to polarization converting reflector 203. Polarization converting reflector 203 may, for example, comprise a quarter wave plate with the fast axis oriented at 45 degrees to the polarization plane of the beam, disposed in front of a flat mirror. The beam back reflected and converted to vertical polarization by polarization converting reflector 203 re-enters and traverses the first prism 201, the coating or other structure 205 and the second prism 202 so that it is coupled to the programmable optical phase modulator 110. The back coupled beam from the programmable optical phase modulator 110 is shown connecting to fiber 101₆. However, the programmable optical phase modulator 110 could programmatically steer the back coupled beam to any fiber for which optical arrangement 120 accepts horizontal polarization.

FIG. 1C shows the path of a beam which originates in fiber 101₅and is vertically polarized upon exiting from the optical arrangement 120. The vertically polarized beam originating at fiber 101₅traverses first prism 201 and the coating or other structure 205 without deviation. The beam also traverses a first portion of the second prism 202 and is reflected from a face of the second prism 202 by, for example, use of a reflective coating on that face. After reflection the beam traverses a second portion of second prism 202, exits, and couples to the programmable optical phase modulator 110. The back coupled beam from the programmable optical phase modulator 110 is shown connecting to fiber 101₁. However, the programmable optical phase modulator 110 could programmatically steer the back coupled beam to any fiber for which optical arrangement 120 accepts vertical polarization.

FIG. 1C shows the path of a beam which originates in fiber 101₅and is vertically polarized upon exiting from the optical arrangement 120. The vertically polarized beam originating at fiber 101₅traverses first prism 201 and the coating or other structure 205 without deviation. The beam also traverses a first portion of the second prism 202 and is reflected from a face of the second prism 202 by, for example, use of a reflective coating on that face. After reflection the beam traverses a second portion of second prism 202, exits, and couples to the programmable optical phase modulator 110. The back coupled beam from the programmable optical phase modulator 110 is shown connecting to fiber 101₁. However, the programmable optical phase modulator 110 could programmatically steer the back coupled beam to any fiber for which optical arrangement 120 accepts vertical polarization.

Note that the vertically polarized beam depicted in FIG. 1C impinges on the programmable optical phase modulator 110 in a region which is spatially displaced from the region of impingement on the programmable optical phase modulator 110 depicted in FIG. 1B. The spatial displacement between the regions of programmable optical phase modulator 110 used for each case allows the programmable optical phase modulator 110 to be programmed to simultaneously and independently form optical connections between pairs of fibers that share a common polarization upon exit of optical arrangement 120.

One important advantage of the optical device described herein is that the path lengths traversed by the wavelength components in each of the subset of ports, which may be treated as independent WSSs, are equal to one another.

The following provides an overview of aspects of the present disclosure:

Aspect 1: An optical device comprising an optical port array having a plurality of optical ports for receiving optical beams; an optical arrangement for allowing optical coupling between (i) any optical ports in a first subset of the plurality of optical ports for light in a first polarization state but not in a second polarization state and (ii) any optical ports in a second subset of the plurality of optical ports for light in the second polarization state but not in the first polarization state, wherein the first and second polarization states are orthogonal to one another; a dispersion element for receiving an optical beam from any of the optical ports after traversing the optical arrangement and spatially separating the optical beam into a plurality of wavelength components; a focusing element for focusing the plurality of wavelength components; a programmable optical phase modulator for receiving the focused plurality of wavelength components, the programmable optical phase modulator being configured to steer the wavelength components to a selected one of the optical ports; a beam directing optical arrangement for coupling the plurality of wavelength components from the focusing element to the programmable optical phase modulator and from the programmable optical phase modulator to the focusing element, the beam directing optical arrangement including: a first prism including an input surface, an output surface and an oblique surface; a second prism including an input surface and an oblique surface, the input surface of the second prism being positioned to face the oblique surface of the first prism; an optical element disposed between the input surface of the second prism and the oblique surface of the first prism, the optical element being configured to reflect the wavelength components in the first polarization state and transmit the wavelength components in the second polarization state; a polarization converting reflector positioned to receive the wavelength components reflected from the optical element in the first polarization state and reflect the wavelength components in the second polarization state so that the wavelength components are directed through the first prism, the optical element and the second prism in the second polarization state and to the programmable optical phase modulator, wherein the wavelength components in the second polarization state that are focused by the focusing element and directed through the first prism and the optical element are directed through the oblique surface of the second prism and to the programmable optical phase modulator.

Aspect 2: The optical device of aspect 1, wherein the second prism of the beam directing optical arrangement has a third surface with a reflective coating, the second prism being arranged so that the wavelength components in the second polarization state are reflected from the third surface before being directed through the oblique surface of the second prism and to the programmable optical phase modulator.

Aspect 3: The optical device of any of aspects 1 through 2, wherein the optical element is a coating on the input surface of the second prism or the oblique surface of the first prism.

Aspect 4: The optical device of any of aspects 1 through 3, wherein the first and second polarization states are linearly polarized states.

Aspect 5: The optical device of any of aspects 1 through 4, wherein the first polarization state is a horizontal polarization state and the second polarization state is a vertical polarization state.

Aspect 6: The optical device of any of aspects 1 through 5, wherein the programmable optical phase modulator includes a liquid crystal-based phase modulator.

Aspect 7. The optical device of aspect 6, wherein the liquid crystal-based phase modulator is a LCoS device.

Aspect 8: The optical device of any of aspects 1 through 7, wherein the dispersion element is selected from the group consisting of a diffraction grating and a prism.

Aspect 9: An optical device, comprising: an optical port array having a plurality of optical ports for receiving optical beams; an optical arrangement for allowing optical coupling between (i) any optical ports in a first subset of the plurality of optical ports for light in a first polarization state but not in a second polarization state and (ii) any optical ports in a second subset of the plurality of optical ports for light in the second polarization state but not in the first polarization state, wherein the first and second polarization states are orthogonal to one another; a dispersion element for receiving an optical beam from any of the optical ports after traversing the optical arrangement and spatially separating the optical beam into a plurality of wavelength components; a focusing element for focusing the plurality of wavelength components; a programmable optical phase modulator for receiving the focused plurality of wavelength components, the programmable optical phase modulator being configured to steer the wavelength components to a selected one of the optical ports; a beam directing optical arrangement for redirecting the wavelength components to couple the plurality of wavelength components from the focusing element to the programmable optical phase modulator and from the programmable optical phase modulator to the focusing element, the beam directing optical arrangement including: a polarization converting reflector, a first prism and a second prism; an optical element receiving the focused plurality of wavelength components from the beam focusing optics after traversing the first prism, the optical element being configured to discriminate between the wavelength components in the first polarization state and the wavelength components in the second polarization state such that the wavelength components in the first polarization state are directed to the polarization converting reflector and the wavelength components in the second polarization state are directed through the second prism and to the programmable optical phase modulator, wherein the wavelength components directed to the polarization converting reflector in the first polarization state are reflected by the polarization converting reflector in the second polarization state and directed through the first prism, the optical element and the second prism and to the programmable optical phase modulator.

Aspect 10: The optical device of aspect 9, wherein the optical element is configured to reflect the wavelength components in the first polarization state to the polarization converting reflector.

Aspect 11: The optical device of any of aspects 9 through 10, wherein the second prism has a reflective surface that reflects the wavelength components in the second polarization state that have not been reflected by the polarization converting reflector such that the wavelength components in the second polarization state are directed to the programmable optical phase modulator after traversing an oblique surface of the second prism.

Aspect 12: The optical device of any of aspects 9 through 11, wherein the programmable optical phase modulator is oriented so that an optical axis through the optical ports is orthogonal to a normal to a surface of the programmable optical phase modulator. The terminology used in the present disclosure is for the purpose of describing particular embodiments only and is not intended to limit the present disclosure. As used in the present disclosure and the appended claims, the singular forms "a," "an," and "the" are intended to include the plural forms as well, unless the context clearly indicates otherwise. It shall also be understood that the term "and/or" used herein is intended to signify and include any or all possible combinations of one or more items listed in the associated list.

The term "coupled" may refer to a relationship between components that supports the flow of signals between the components. Components are considered coupled with one another if there is any conductive path (e.g., optical path) between the components that can, at any time, support the flow of signals between the components. The conductive path between coupled components may be a direct conductive path between the components or the conductive path between coupled components may be an indirect conductive path that may include intermediate components.

It shall be understood that although the terms "first," "second," "third," etc. may be used herein to describe various information, the information should not be limited by these terms. These terms are only used to distinguish one category of information from another. For example, without departing from the scope of the present disclosure, the first information may be termed as second information, and similarly, the second information may also be termed as first information.

As used herein, including in the claims, "or" as used in a list of items (e.g., a list of items prefaced by a phrase such as "at least one of' or "one or more of') indicates an inclusive list such that, for example, a list of at least one of A, B, or C means A or B or C or AB or AC or BC or ABC (i.e., A and B and C). Also, as used herein, the phrase "based on" shall not be construed as a reference to a closed set of conditions. For example, an example step that is described as "based on condition A" may be based on both a condition A and a condition B without departing from the scope of the present disclosure. In other words, as used herein, the phrase "based on" shall be construed in the same manner as the phrase "based at least in part on."

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein but may be modified within the scope and equivalent of the appended claims.

1. An optical device, comprising:
an optical port array having a plurality of optical ports for receiving optical beams;
an optical arrangement for allowing optical coupling between (i) any optical ports in a first subset of the plurality of optical ports for light in a first polarization state but not in a second polarization state and (ii) any optical ports in a second subset of the plurality of ports for light in the second polarization state but not in the first polarization state, wherein the first and second polarization states are orthogonal to one another;
a dispersion element for receiving an optical beam from any of the optical ports after traversing the optical arrangement and spatially separating the optical beam into a plurality of wavelength components;
a focusing element for focusing the plurality of wavelength components;
a programmable optical phase modulator for receiving the focused plurality of wavelength components, the programmable optical phase modulator being configured to steer the wavelength components to a selected one of the optical ports;
a beam directing optical arrangement for coupling the plurality of wavelength components from the focusing element to the programmable optical phase modulator and from the programmable optical phase modulator to the focusing element, the beam directing optical arrangement including:
a first prism including an input surface, an output surface and an oblique surface;
a second prism including an input surface and an oblique surface, the input surface of the second prism being positioned to face the oblique surface of the first prism;
an optical element disposed between the input surface of the second prism and the oblique surface of the first prism, the optical element being configured to reflect the wavelength components in the first polarization state and transmit the wavelength components in the second polarization state;
a polarization converting reflector positioned to receive the wavelength components reflected from the optical element in the first polarization state and reflect the wavelength components in the second polarization state so that the wavelength components are directed through the first prism, the optical element and the second prism in the second polarization state and to the programmable optical phase modulator,
wherein the wavelength components in the second polarization state that are focused by the focusing element and directed through the first prism and the optical element are directed through the oblique surface of the second prism and to the programmable optical phase modulator.

2. The optical device of claim 1, wherein the second prism of the beam directing optical arrangement has a third surface with a reflective coating, the second prism being arranged so that the wavelength components in the second polarization state are reflected from the third surface before being directed through the oblique surface of the second prism and to the programmable optical phase modulator.

3. The optical device of claim 1, wherein the optical element is a coating on the input surface of the second prism or the oblique surface of the first prism.

4. The optical device of claim 1, wherein the first and second polarization states are linearly polarized states.

5. The optical device of claim 4, wherein the first polarization state is a horizontal polarization state and the second polarization state is a vertical polarization state.

6. The optical device of claim 1, wherein the programmable optical phase modulator includes a liquid crystal-based phase modulator.

7. The optical device of claim 6, wherein the liquid crystal-based phase modulator is a LCoS device.

8. The optical device of claim 1, wherein the dispersion element is selected from the group consisting of a diffraction grating and a prism.

9. An optical device, comprising:
an optical port array having a series of optical ports for receiving optical beams;
an optical arrangement for allowing optical coupling between (i) any optical ports in a first subset of the series of optical ports for light in a first polarization state but not in a second polarization state and (ii) any optical ports in a second subset of the series of optical ports for light in the second polarization state but not in the first polarization state, wherein the first and second polarization states are orthogonal to one another;
a dispersion element for receiving an optical beam from any of the optical ports after traversing the optical arrangement and spatially separating the optical beam into a plurality of wavelength components;
a focusing element for focusing the plurality of wavelength components;
a programmable optical phase modulator for receiving the focused plurality of wavelength components, the programmable optical phase modulator being configured to steer the wavelength components to a selected one of the optical ports;
a beam directing optical arrangement for redirecting the wavelength components to couple the plurality of wavelength components from the focusing element to the programmable optical phase modulator and from the programmable optical phase modulator to the focusing element, the beam directing optical arrangement including:
a polarization converting reflector;
a first prism;
a second prism; and
an optical element receiving the focused plurality of wavelength components from the beam focusing optics after traversing the first prism, the optical element being configured to discriminate between the wavelength components in the first polarization state and the wavelength components in the second polarization state such that the wavelength components in the first polarization state are directed to the polarization converting reflector and the wavelength components in the second polarization state are directed through the second prism and to the programmable optical phase modulator,
wherein the wavelength components directed to the polarization converting reflector in the first polarization state are reflected by the polarization converting reflector in the second polarization state and directed through the first prism, the optical element and the second prism and to the programmable optical phase modulator.

10. The optical device of claim 9, wherein the optical element is configured to reflect the wavelength components in the first polarization state to the polarization converting reflector.

11. The optical device of claim 9, wherein the second prism has a reflective surface that reflects the wavelength components in the second polarization state that have not been reflected by the polarization converting reflector such that the wavelength components in the second polarization state are directed to the programmable optical phase modulator after traversing an oblique surface of the second prism.

12. The optical device of claim 9, wherein the programmable optical phase modulator is oriented so that an optical axis through the optical ports is orthogonal to a normal to a surface of the programmable optical phase modulator.
